(19) United States
(12) Patent Application Publication
(10) Pub. No.: US 2005/0024668 A1
(43) Pub. Date: Feb. 3, 2005

(54) Method, computer and computer program to administer resources for use in a resource-based document data stream

(76) Inventor: Jorg Schmidt, Munchen (DE)

Correspondence Address: SCHIFF HARDIN LLP;Patent Department, 6600 Sears Tower, 233 South Wacker Drive, Chicago, IL, 60606, US

(21) Appl. No.: 10/860,923

(22) Filed: Jun. 4, 2004

(30) Foreign Application Priority Data
Jun. 6, 2003 (DE) 103 25 843.4

(51) Int. Cl. G06F 15/00

(52) U.S. Cl. 358/1.13; 358/1.1

(57) ABSTRACT

In a method, a computer and a computer program for administration of a resource containing resource data for use in a resource-based document data stream that includes variable document data, at least one internal resource and/or at least one call on an external resource, the document data stream is subject to a parsing event in which it is checked for consistency with predetermined rules. In addition to a resource name, an identification datum is thereby associated with the resource, the identification datum unambiguously identifying the resource relative to all other resources of the document data stream. For representation of the document data on a reproduction device, the resource is called once or multiple times by means of the resource name and/or the identification datum within the document data stream.

### BACKGROUND OF THE INVENTION

1. Field of the Invention

The present invention relates generally to a method, computer and computer program to administer resources for use in a resource-based document data stream. In particular, the invention relates to a method and a system for processing of a print data stream that is prepared for output on a print device.

2. Description of the Related Art

Preparation of data in a print data stream to output to a printer typically ensues in computers that generate a printer-adapted output print data stream from variable print data and from resource data such as, for example, fonts, overlays, object containers, etc. The print data can thereby, for example, be read in the printer data language AFP® (Advanced Function Presentation) and output in the printer data language IPDS (Intelligent Printer Data Stream), or in another resource-based document data language such as Printer Control Language (PCL) or Extensible Markup Language (XML) that use external resources.

In the representation of AFP document data, resources that exist at various locations in the AFP document data stream or, respectively, originate from various sources are combined with the corresponding variable data. The resource data can thereby be included as internal resources in the document data stream or be called, or invoked from libraries as external resources via a resource name. Furthermore, the data are checked for consistency in a parsing event.

In large-scale computer centers, large quantities of print data (that can comprise up to some ten-thousand pages) are typically combined or merged (in a spooling event) in a host computer (such as a mainframe computer), and from this print jobs (jobs) are generated that are adapted for output on high-capacity printing systems such that the high-capacity printing systems can be optimally temporally loaded in the production operation. They can thereby largely be used in continuous operation. Mainframe computers are frequently operated with the operating systems OS/390 or z/OS.

To process AFP print jobs, suitable high-capacity printers with printing speeds of approximately 40 DIN A 4 pages per minute, up to over 1000 DIN A 4 pages per minute, are, for example, described in the publication “Das Druckerbuch”, published by Dr. Gerd Goldmann (Océ Printing Systems GmbH), 6th edition, May 2001, ISBN 3-000-00 1019-X. Disclosed in chapter 14 (pages 14-1 through 14-20) of this publication is the server system known under the name PRISMA PRO® which serves for the preparation of print data streams in production print environments.

The document data formats AFP (Advanced Function Presentation) and line data) are, for example, described in the publication NR. F-544-3884-01 by the company International Business Machines Corp. (IBM) with the title “AFP Programming Guide and Line Data Reference”. The document data stream AFP was further developed into the document data stream MO:DCA, which is described in the IBM publication SC31-6802-04 with the title “Mixed Object Document Content Architecture Reference”. In the following, the document data streams just cited are designated in a simplified manner as AFP data streams.

In the document “Print Services Facility for OS/390 & z/OS, Introduction”, Vers. 3, Release 3.0 Nr. G544-5625-03 by the company IBM in March 2002, details are described as to how a line data document data stream or, respectively, MO:DCA document data stream is converted into an IPDS data stream. The software program Print Service Facility (PSF) thereby combines variable document data with resource data into output data that are sent to a printer as an output device for administration and control.

### SUMMARY OF THE INVENTION

The present invention provides a method, a computer and a computer program with which resources for complex, resource-based document data streams can be administered such that the resource calls respectively ensue correctly. In particular, the invention provides a method for administration of a resource containing resource data for use in a resource-based document data stream that comprises variable document data, at least one internal resource and/or at least one call on an external resource: whereby the document data stream is subject to a parsing event in which it is checked for consistency with predetermined rules; whereby, in addition to a resource name, an identification datum is thereby associated with the resource, said identification datum unambiguously identifying the resource relative to all other resources of the document data stream; and whereby, for representation of the document data on a reproduction device, the resource is called once or multiple times by means of the resource name and/or the identification datum within the document data stream. A computer to implement the method and a print system to perform the method are also provided.

### BRIEF DESCRIPTION OF THE DRAWINGS

Further features, advantages and effects of the invention result from the subsequent exemplary embodiment, which is explained using the following Figures.

FIG. 1 is a functional block diagram of a printing system according to the invention;

FIG. 2 is a schematic diagram showing the inventive use of a resource;

FIG. 3 is a schematic diagram showing the check-in and check-out of a resource;

FIG. 4 is a schematic diagram showing the dismantling and regrouping of a document data stream; and

FIG. 5 is a schematic diagram showing the modification of resources in a document data stream.

### DETAILED DESCRIPTION OF THE PREFERRED EMBODIMENTS

According to a first aspect of the invention, for administration of a resource containing resource data for use in a resource-based document data stream that comprises variable document data, at least one internal resource and/or at least one call on an external resource, the document data stream is subject to a parsing event in which it is checked for consistency with predetermined rules. In addition to a resource name, an identification datum is thereby associated with the resource, the identification datum unambiguously identifying the resource relative to all other resources of the document data stream. For representation of the document data on a reproduction device, the resource is called once or multiple times by means of the resource name and/or the identification datum within the document data stream.

With the invention, a clear identification of the resources of a document data stream are provided. This is primarily advantageous when the same resource is called multiple times within a document data stream. Given such multiple calls, it can occur that a resource is modified in the course of a first call and is then no longer called in the original state in the course of another, subsequent call, but rather is called in the changed state. Reproduction errors can thereby be created, in particular when a document data stream is re-sorted and was necessary for the subsequent call of the original resource. The invention precludes such errors, in that it already identifies the respective resources and provides them with an unambiguous identification datum before the reproduction, in particular in the course of the parsing event. The resource or, respectively, the resource call associated with the resource in the document data stream undergoes a check-in process with the call, whereby in particular time-stamp data are used that characterize the input of the resource in a data processing units such as, for example, in a parsing unit. This identification datum is associated with the resource in the course of the input. Given each change of the resource in the document data stream, a corresponding individual time stamp can furthermore be generated, and the resource can be reproduced true to the original in the downstream representation event. When a resources is changed at least once in the course of the representation of the document data, a new identification datum is generated and associated with the resource in the course of the change.

In an advantageous embodiment of the invention, the identification data comprises at least one of the following data: a resource identification number, a generation datum, a generation time, author data, data about the position or the use of the resource in a job, in a file and/or in a page.

Based on the identification data, it is possible without anything further ado to administer multiple calls of a resource within a document data stream. The resource can thereby be generated once and used many times, or a resource can be changed within one event, for example the parsing, and a plurality of resource data sets can correspondingly be stored, whereby a first resource data set is the unchanged resource for a first call and a second resource data set is the changed resource in a second call. Via allocation of a current number for resource data to the same resource, it is also, for example, possible to implement a resource administration to the effect that, respectively, the resource with the newest generation datum or, respectively, the most current number is used, and all other, older resource data of the same resource are erased.

According to a second aspect of the invention that can also be viewed as independent of the previously cited aspect of the invention, it was recognized that resources are critical components in the document data streams, in particular when they are provided as external resources. According to a second aspect of the invention, a registration event (or check-in) is provided with which, as specified above, the changes to resources can be detected such that a precise administration of the resources can ensue. According to a second aspect of the invention, however, a check-out event (or check-out) can also be applied, via which the registered external resources are made available to the document data stream. The original and/or the changed resources can thereby be stored externally or internally in the document data stream.

A third aspect of the invention concerns the registration event (or check-in) of the resources for the case that a resource is changed within a document data stream upon preparation of the document data stream in the course of its representation on a reproduction device. According to the third aspect of the invention, it was recognized that it can lead to errors when an already existing identification datum is changed on the resource without additional checking, or when resources are filtered from the document data stream or loaded beforehand during the run time of the representation of the document data stream.

According to this aspect of the invention, that can also be viewed as independent of the first aspect and second aspect of the invention, the identification data comprise a designation about the validity range of the resource. This designation can in particular correspond to the information “permanent”, “temporary” or “specific”: whereby a resource characterized as “permanent” is used for all jobs and all calls that call this resource; whereby a resource characterized as “temporary” is used for jobs belonging together and those calls with which this resources is called; and whereby a resource characterized as “specific” is used for one job and those calls with which this resource is called. Furthermore, it cryptographic algorithms be inventively provided to provide an external resource with the identification data in the course of the parsing event, and to provide calls of the external resource in the document data stream with the respectively associated identification data. In particular, an Advanced Function Presentation data stream, a PCL data stream or an XML data stream is used as a document data stream.

A print data stream is in particular used as a document data stream, and a print device is in particular used as a reproduction device. The resource is in particular an external resource that, in the document data stream, is called with the resource name from a library separate from the document data stream.

A further aspect of the invention concerns a print system with an inventive resource management.

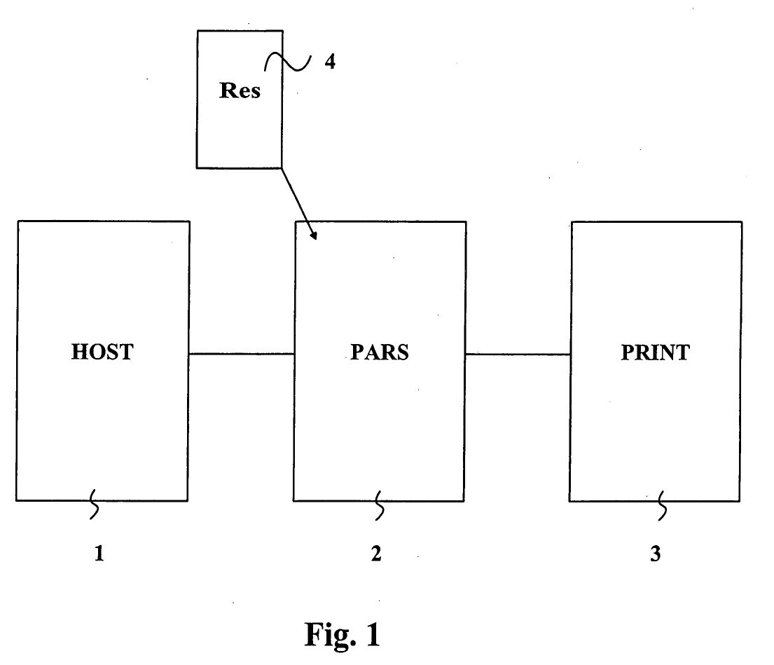

In FIG. 1, a print production system is shown that comprises a host computer 1, a print server 2 and a high-capacity printing device 3. In the host computer 1, on the one hand are variable print data, for example generated from a databank, and on the other hand are a paged file and a formed file (comprising resources) from which an Advanced Function Presentation data stream is formed. The document data stream thus generated is supplied to the print server 2 in which the document data stream is prepared and converted into an Intelligent Printer Datastream (IPDS) for output to the print device 3. For this, a plurality of processes that are controlled by software modules run in the print server 2. A first software module incorporates further resource data 4 (such as, for example, fonts or overlays) that are called in the original document data stream into the original document data stream. A second software module, the parsing module, checks the document data stream for consistency with predetermined rules. Upstream from the parsing event is a pre-parsing event that is implemented by a corresponding software module in which, in addition to resource names, an identification datum is associated with each resource call and the associated resource file, via which identification datum the resource is unambiguously identified with regard to all other resources of the document data stream. Within the document data stream, the resource can then be called once or multiple times (by means of the resource name and/or the identification datum) for representation of the document data and the resource data on the print device 3. The processes shown here in the print server can also be partially or completely implemented in a controller of the print device. In the print device, the IPDS data stream is rastered and the documents are printed out.

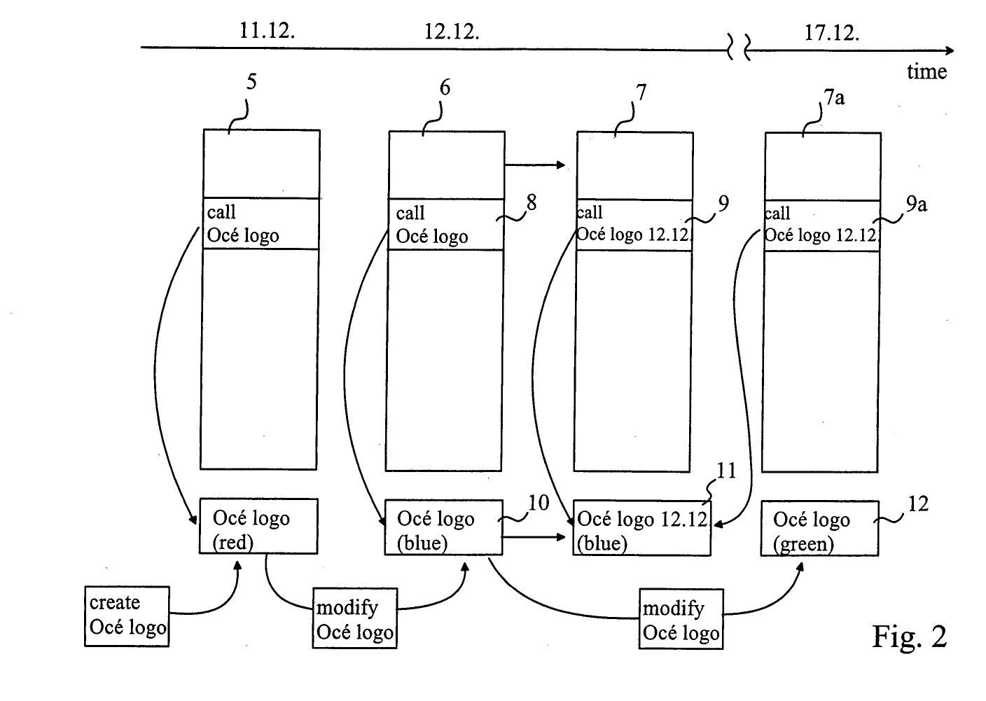

In FIG. 2, various document data streams are shown that are respectively used at various datum points in time 11.12., 12.12. and 17.12., and respectively access a specific resource “Océ Logo”. The first document data stream 5, which calls the originally generated resource “Océ Logo” on 11.12., thereby comprises the logo data red. The documents of the document data stream are correspondingly printed out with red Océ logos. An association of an identification datum does not ensue. The second document data stream 6, which is printed out on 12.12., likewise calls the resource “Océ Logo”. In the meantime, however, this resource was modified with regard to color from red to blue. Before, during or after the parsing event, the resource call 8 and the resource 10 are provided with an identification datum, 12.12., whereby a modified data stream 7 is generated with a modified logo call 9 and a modified resource 11. When the modified document data stream is not called again as a repeat data stream at a later point in time (17.12), the resource 11 from 12.12. can be precisely accessed via the unambiguous association of the correct logo datum in the repeated resource call 9a. It is thereby possible, with regard to resources, to ensure a 100% identity between a printed document at a first point in time and a repeated printed document at a second point in time, even when, as in the present example, the resource (here the Océ Logo 12) has been modified again, here to green. Such a method is, for example, advantageous when jobs should be reprinted true to the original at a later point in time.

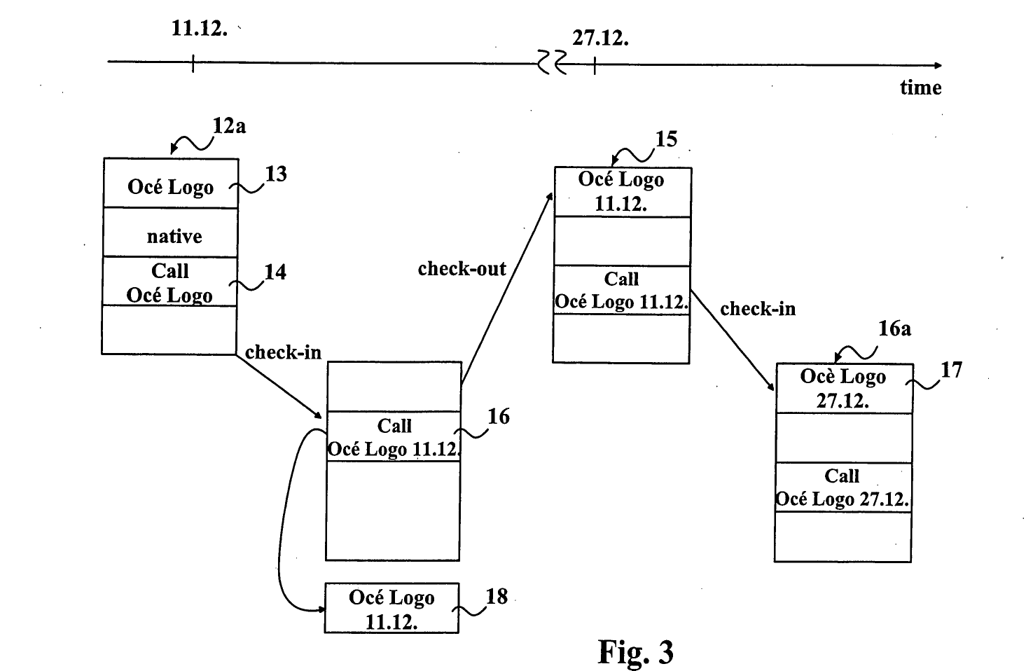

In FIG. 3, it is shown how resources are checked in and checked out. A generic print file 12 (Native Print File) comprises an inline resource 13 and a call 14 for the inline resource 13. Upon checking in the generic print file 12 in the course of a parsing event, the inline resource 13 is swapped out, or paged, to an external resource 15, and the current calendar date 11.12. is added to both the external resource 15 and its call 16 as an identification datum. In the course of checking out, a print file 15 is then created in which the resource “Océ Logo 11.12.” is in turn incorporated into the print file 15 as an inline resource. However, in this file all resources are clearly provided with the data identifier that characterizes the correct version of the resource. It is thereby ensured that, given printout of the file 15 on an output system that does not execute a check-in event according to the invention, the correct resource is used for all resource calls.

When the print file 15 should be reprinted at a later point in time, it passes through a check-in event again, whereby a menu-driven query ensues as to whether the original or the current resources should be used. When the current resources should be used, the system control automatically changes the datum of the resource calls to 27.12. and searches in to the available resources for the optimally youngest resources. For example, the resource “Océ Logo 27.12.” 17 is loaded into the then-generated print file 16.

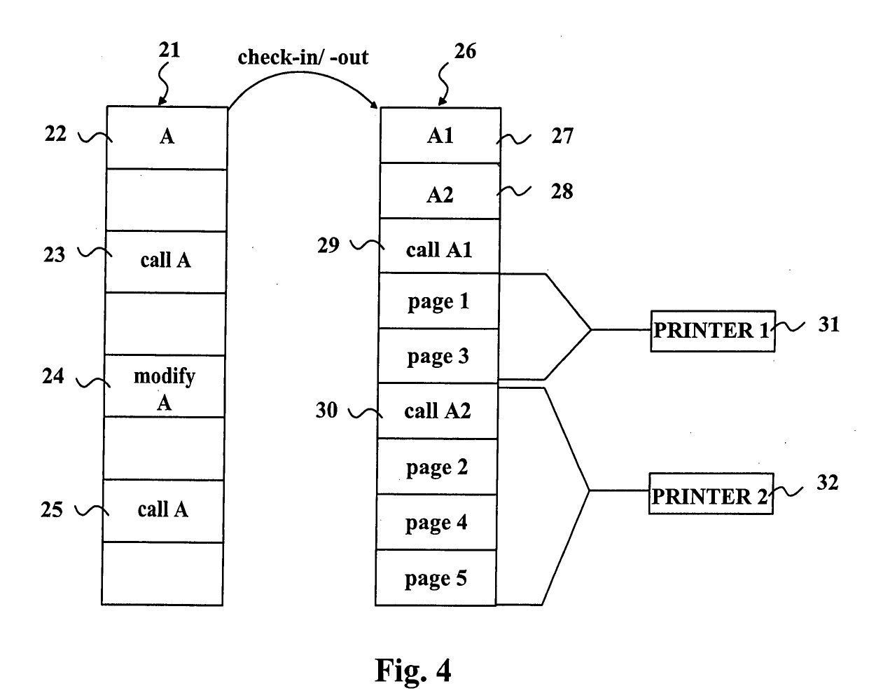

In FIG. 4, it is shown how a print data stream in which a resource is called multiple times and modified once is regrouped and the various groups (printout ranges) are sent to different print devices. A print data stream 21 comprises a resource A 22, a first resource call 23, a range 24 in which the resource A is modified, and a second resource call 25. When the print file 21 is checked in and checked out as specified above, a modified print file 26 results in which both inline resources 27 and 28 are comprised. The inline resource 27 corresponds exactly to the resource 22, and the inline resource 28 corresponds to the resource that is created via the modification in the range 24. Both inline resources 27 and 28 are respectively provided with an unambiguous identification characteristic, here a current number, and their corresponding calls 29 and 30 likewise carry this reference number. Based on these unambiguous associations of the calls and the resources, it is possible to also modify the modified print file 26 in the page sequence relative to the print file 21 such that, for example, page 2 is first processed after page 3. Such a regrouping is, for example, advantageous when specific pages are collected for a specific printer, for example color pages 1 and 3 should be sent to the color printer 31. The transmission of the print data to a specific printer line, in which additional devices for processing of printing goods (such as, for example, a cutting device, a binding device, a gluing device or an insertion device) are connected, can also make a regrouping sensible. While the modified or, respectively, normalized print data stream 26 in FIG. 4 has incorporated the changed resources as inline resources, the resources can alternatively also be stored and administered as external resources.

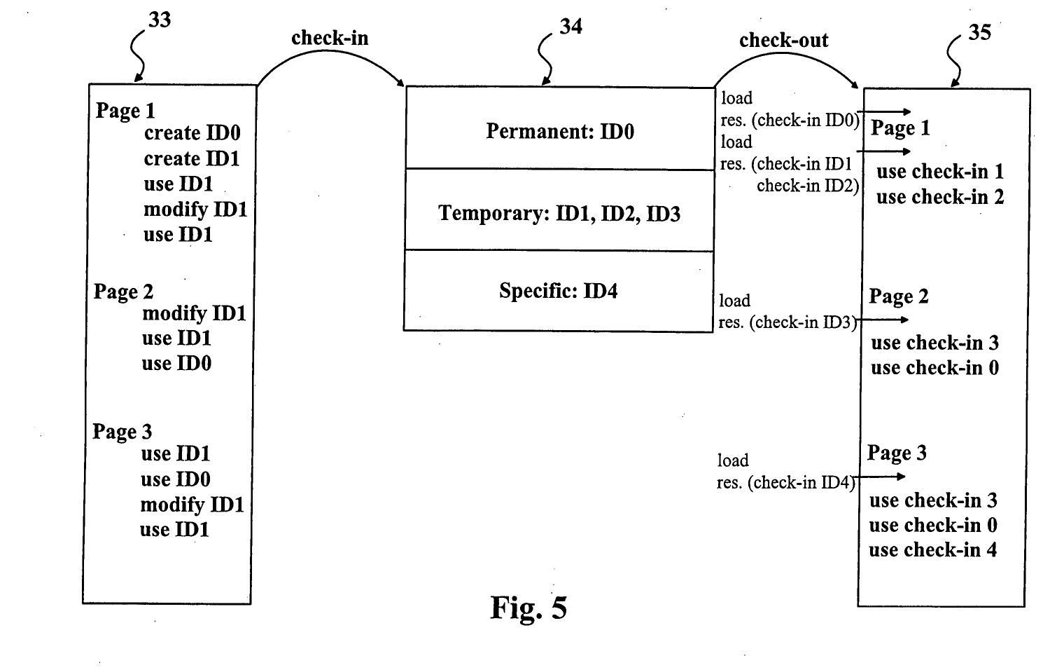

In FIG. 5, it is shown how resources for a document data stream 33 are administered. Two resources ID0 and ID1 are generated as an output situation. In page 1, the resource ID1 is used and subsequently modified. This modified resource ID1 is likewise used in page 1. In page 2, the resource ID1 is modified again and subsequently used. Furthermore, on page 2 the resource ID0 is used. On page 3, the resources ID1 and ID0 are used again in the current version. The resource ID1 is modified again after this and used immediately.

In the course of the check-in event, a resource library 34 is created in which resources used in the document data stream 33 are collected. The changed variants of the resource ID1 are thereby provided with new numbers in order to unambiguously differentiate the variants from one another: this, the first modified variant of ID1 is designated as ID2, the second modified variant of ID1 is designated as ID3, and the third modified variant of ID1 is designated as ID4. Furthermore, the resources are characterized and sorted according to the criteria “permanent”, “temporary” and “specific”. Such resources that are used in all pages or, respectively, processing jobs, for example the resource ID0, are thereby characterized as “permanent”. Such resources that are used in multiple pages or, respectively, page processing jobs, for example the resources ID1, ID2 and ID3, are thereby characterized as “temporary”. Those that are used on only one page or, respectively, only in one page processing job, for example the resource ID4, are characterized as “specific”. In the subsequent check-out event, an output document data stream 35 is generated from the original document data stream 33 and the resource library 34, the necessary resources being loaded as inline resources in said document data stream 35 per page or, respectively, per page processing job, and the corresponding calls of the resources ensuing using the exact resource number. The possibility also exists in this example to process each page sequence without losing the resource information, because all necessary resources of one page are loaded within this page or, respectively, have already been loaded beforehand in the superordinate pages or, respectively, a superordinate range. In particular, standard fonts and overlays can thereby be loaded as internal permanent resources; other resources can be designated as external resources. This is true primarily for permanent resources.

The invention is in particular suited to be realized as a computer program (software). It thereby in particular comprises the check-in computer program module and the check-out computer program module, and can be distributed as a file or, respectively, file collection on a data medium such as a diskette or CD-ROM, or via a data or, respectively, communication network. Such and comparable computer program products or computer program elements are embodiments of the invention.

The inventive process can be applied in a computer, in a print device or in a print system with upstream or downstream data processing devices. It is thereby clear that corresponding computers on which the invention is applied can comprises further known technical devices such as input means (keyboard, mouse, touchscreen), a microprocessor, a data bus or, respectively, control bus, a display device (monitor, display) and a working storage, a fixed disk storage, and a network card.

Although other modifications and changes may be suggested by those skilled in the art, it is the intention of the inventors to embody within the patent warranted hereon all changes and modifications as reasonably and properly come within the scope of their contribution to the art.

1. A method for administration of a resource containing resource data for use in a resource-based document data stream that includes at least one of variable document data and at least one internal resource and at least one call on an external resource, comprising the steps of:
subjecting the document data stream to a parsing event in which it is checked for consistency with predetermined rules;
associating an identification datum and a resource name with the resource, said identification datum unambiguously identifying the resource relative to all other resources of the document data stream; and
calling the resource at least once by at least one of the resource name and the identification datum within the document data stream for representation of the document data on a reproduction device.

2. A method according to claim 1, wherein said identification datum is time-stamp data that identify the input of the resource in a data processing unit, the time stamp data being associated with the resource during input.

3. A method according to claim 1, further comprising the step of:
generating the resource once and using the resource multiple times.

4. A method according claim 1, further comprising the steps of:
changing the resource at least once in a course of representation of the document data, and generating new identification data during said changing step; and
associating the new identification data with the resource.

5. A method according to claim 1, wherein said identification datum includes at least one data selected from the following group: a resource identification number, a generation datum, a generation time, author data, data about the position of the call and data about the use of the resource in at least one of a job and a file and a page.

6. A method according to claim 1, further comprising the step of:
providing an external resource with the identification data during the parsing event; and
providing calls of the external resource in the document data stream with the respectively associated identification data.

7. A method according to claim 1, wherein said document data stream is an Advanced Function Presentation data stream.

8. A method according to claim 1, wherein the identification data includes a specification about a validity range of the resource.

9. A method according to claim 8, wherein the specification about the validity range of the information corresponds to information characterized as one of permanent and temporary and specific;
a resource characterized as permanent being used for all jobs and all calls that call this resource;
a resource characterized as being temporary being used for jobs belonging together and those calls with which this resources is called; and
a resource characterized as specific being used for one job and those calls with which this resource is called.

10. A method according to claim 1, further comprising the steps of:
using a print data stream is used as the document data stream, and
using a print device as a reproduction device.

11. A method according to claim 1, wherein the resource is an external resource that is called in the document data stream with a resource name from a library separate from the document data stream.

12. A computer programmed to implement a method for administration of a resource containing resource data for use in a resource-based document data stream that includes at least one of variable document data and at least one internal resource and at least one call on an external resource, comprising the steps of:
subjecting the document data stream to a parsing event in which it is checked for consistency with predetermined rules;
associating an identification datum and a resource name with the resource, said identification datum unambiguously identifying the resource relative to all other resources of the document data stream; and
calling the resource at least once by at least one of the resource name and the identification datum within the document data stream for representation of the document data on a reproduction device.

13. A print system comprising a computer programmed to implement a method for administration of a resource containing resource data for use in a resource-based document data stream that includes at least one of variable document data and at least one internal resource and at least one call on an external resource, comprising the steps of:
subjecting the document data stream to a parsing event in which it is checked for consistency with predetermined rules;
associating an identification datum and a resource name with the resource, said identification datum unambiguously identifying the resource relative to all other resources of the document data stream; and
calling the resource at least once by at least one of the resource name and the identification datum within the document data stream for representation of the document data on a reproduction device.

14. A computer program that when loaded and executed on a computer carries out a method for administration of a resource containing resource data for use in a resource-based document data stream that includes at least one of variable document data and at least one internal resource and at least one call on an external resource, comprising the steps of:
subjecting the document data stream to a parsing event in which it is checked for consistency with predetermined rules;
associating an identification datum and a resource name with the resource, said identification datum unambiguously identifying the resource relative to all other resources of the document data stream; and
calling the resource at least once by at least one of the resource name and the identification datum within the document data stream for representation of the document data on a reproduction device.
